(19) United States
(12) Patent Application Publication
(10) Pub. No.: US 2010/0101129 A1
(43) Pub. Date: Apr. 29, 2010

(54) CLEAR PLASTIC STAND-UP POCKET CHART

(76) Inventor: Darin Smith, Westminster, CA (US)

Correspondence Address: STEVEN W. WEBB, 825 College Blvd., Suite 102620, Oceanside, CA, 92057, US

(21) Appl. No.: 12/260,870

(22) Filed: Oct. 29, 2008

(51) Int. Cl. G09F 15/00

(52) U.S. Cl. 40/606.01

(57) ABSTRACT

An transportable presentation support system comprised of a standup, multi-pocket display chart is presented. The chart has the additional features of a transparent slot pocket that runs the length and width of the display chart that accommodates a background poster, over which symbol and word cards can be placed in the transparent pockets covering the front of the display chart. The cards can illustrate the underlying poster.

The display chart itself can be transparent and can have transparent slot pockets and transparent card pockets on both sides of the standup. The sides of the standup are held together with a fanfold bottom, which permits the display chart to stand on its end on a table or other surface.

### FIELD OF THE INVENTION

This invention relates to display systems and presentation charts, plastic display devices, and flip charts.

### BACKGROUND OF THE INVENTION

Business and educational instructors use physical media to make presentations and to illustrate concepts, including arrangements of ideas on flip charts or presentation posters. The types of presentation media include physical media such as plastic sheets where sticky notes or writing can be placed and easels for paper flip charts.

The present invention is a new form of stand-up, self-supporting, portable plastic sheet presentation system with a unique transparent pocket design to hold preprinted cards, symbols, and other items. The present invention's display background pockets can accommodate medium and small activity charts, such as maps, paintings, and pictures. The transparent pockets can hold single cards containing words or symbols used to supplement or illustrate the background display.

The prior art includes media such as U.S. Pat. No. 5,485,694 to Goad, teaching a poster support capable of being hung on the back of a door, and U.S. Pat. No. 3,187,903 to Oltz, teaching a typical plastic pocket system that could hold and contain miscellaneous items. More specific versions of the Oltz design can be found in U.S. Pat. No. 5,682,695 to Hoffman, showing a combination presentation organizer, and U.S. Pat. No. 5,533,902 to Miller showing an educational presentation display system.

The present invention can be distinguished by the addition of a back panel map holder, a more modular pocket design, and optional transparent or opaque backing for the maps. A closeable pocket is an optional feature.

### SUMMARY OF THE INVENTION

The invention consists of two sides, joined at the top and at the bottom, with a fan-fold connection at the bottom. The fan-fold permits the invention to be stood up on the bottom and remain stable. The front side has two panels, seamed together on three sides, forming an inside pocket for inserting backing sheets. The inserted sheets serve as a background for items to be placed in the front card pockets. The front card pockets are placed on the front panel.

A backing sheet is made with a landscape orientation to fit the inside pocket. The rear panel can be opaque or transparent. If the rear panel is transparent, a transparent backing sheet inserted in the inside pocket will pass light through.

A typical use for the present invention would involve putting a backing sheet in the inside pocket, such as a map, and then using the front pockets to place symbols or place names in front of the backing sheet, illustrating it.

Users can insert plain paper or purchase insert ‘kits’ to vary their displays. Because in the preferred embodiment the front panel is clear, this pocket chart product is more versatile than traditional charts, since it allows the user to insert both commercial and noncommercial materials on the outside and interior pockets. Sets of interactive backing sheets and cards will be published to use with the pocket charts. However, these pocket charts can also be used independently.

In the preferred embodiment, the rear side is opaque and has a closeable pocket on its outside surface, with a closure made from a hook and loop closure mechanism. In an alternate embodiment, the rear panel is transparent and, like the front panel, has an inside pocket and card pockets that can be used as the front side is used.

### OBJECTIVES OF THE PRESENT INVENTION

The objective of the present invention is to provide a methodology for illustrating educational or business presentations by means of controlling the placement of descriptive words or symbols on top of a background image.

A further objective of this invention is to make the methodology portable and cost-efficient to use.

A further objective of the present invention is to allow the methodology to be implemented with lightweight materials, suitable for the use of children.

A further objective of the present invention is to permit all types of background sheets to be clearly seen.

### BRIEF DESCRIPTION OF THE DRAWINGS

FIG. 1. Perspective view of the front side of the invention

FIG. 2. Perspective view of the rear side of the invention

FIG. 3. Perspective view of the alternate embodiment of the invention

### DETAILED SPECIFICATION

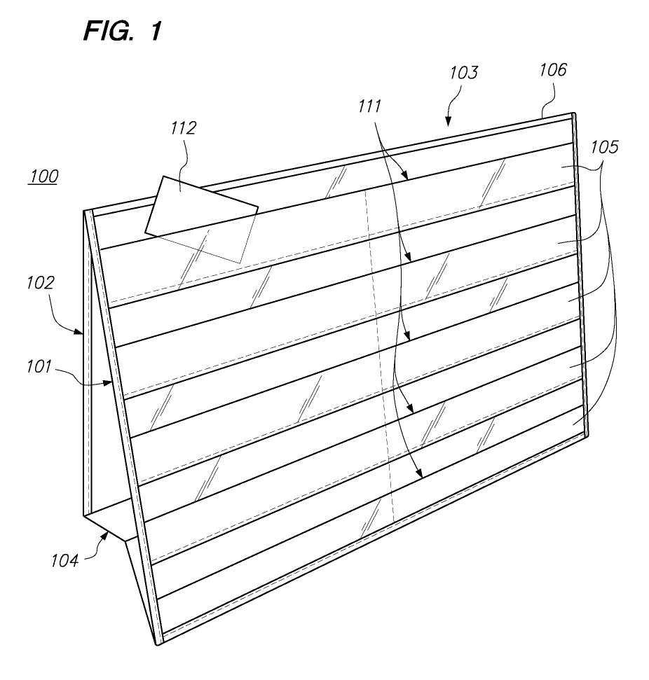

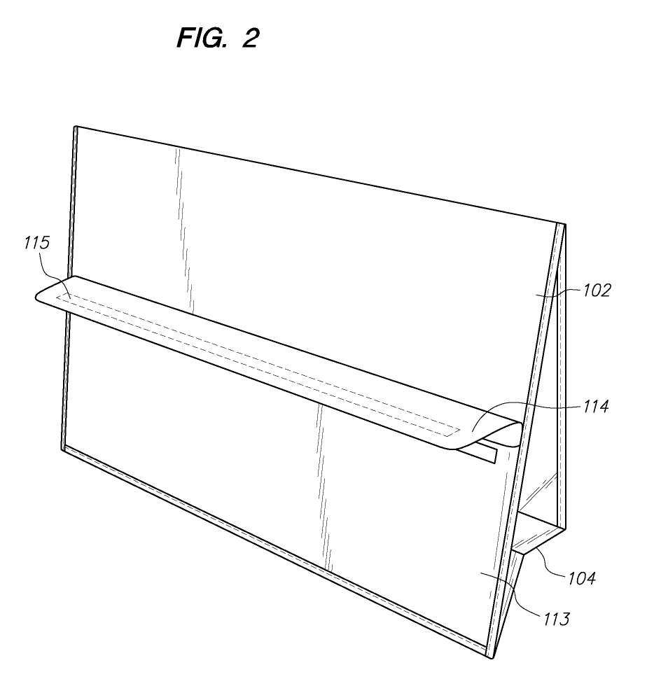

As shown in FIG. 1 and FIG. 2, the present invention 100 is comprised two sides, the front side 101 and the rear side 102. The two sides are joined at the top edge 103 and at a fan-fold 104 at the bottom edge. On the front side 101 outer surface, there is a transparent inside pocket 106, which is connected to the front side 101 outer surface at three sides, and is open at the top.

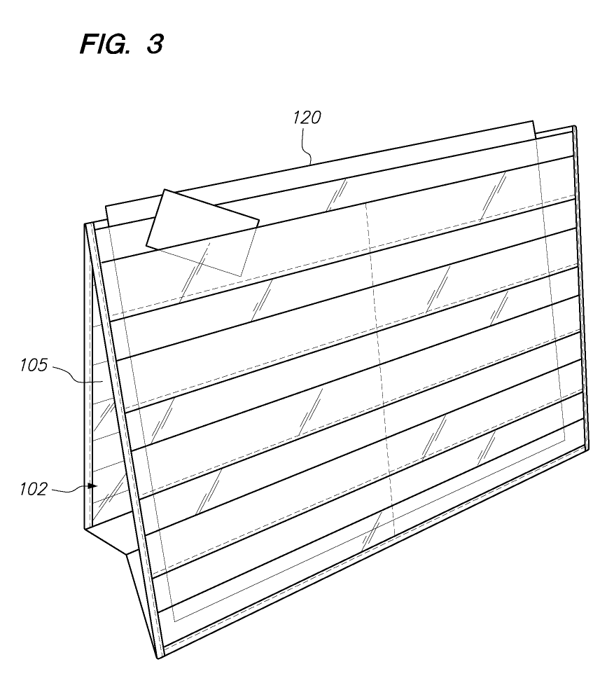

The transparent inside pocket 106 possesses a plurality of transparent pockets 105 on its surface, as shown in FIG. 1. The pockets 105 have an open top 111 and are closed on the other three sides. Cards 112 may be placed in the pockets 105 as shown in FIG. 1. A background poster 120 can be inserted into the transparent inside pocket 106 such that it can be seen through the transparent pockets 105, as in FIG. 3.

The orientation of the pockets 105 is such that when the invention 100 is stood on its fan-fold 104, the background poster 120 held in the transparent inside pocket 106 and the contents of the pockets 105 may be seen. In the preferred embodiment, as in FIG. 2, the rear side 102 is opaque and possesses a long storage pocket 113, closed by a hook and loop closure mechanism 115 on the flap 114 of the storage pocket 112. Cards 105 and other items can be stored in the storage pocket 113 and carried along with the invention 100.

In an alternate embodiment, as in FIG. 3, the rear side 102 of the invention 100 is also transparent, as is the front side 101. The rear side also possess a transparent inside pocket 106 and pockets 105 like the front side, which are used in a similar manner.

The invention 100 is used by means of the steps of deciding which poster 120 to place in the inside pocket 106, which cards 112 to use in the transparent pockets 105, and then assembling the invention 100 plus the other items by placing the cards 112 and background poster 120 in the storage pocket 113. The invention 100 can then be carried to the place where it is to be displayed, the contents of the storage pocket 106 removed, the background poster 120 inserted into the inside pocket 106, the cards 112 inserted into the transparent pockets 105 as desired, and a presentation made. The cards 111 and be removed and replaced as desired during the presentation.

While the foregoing describes a preferred mode and an alternate embodiment, variation on this design and equivalent methods may be resorted to in the scope and spirit of the claimed invention.

What is claimed is:

1. a standup pocket chart comprised of a front part, a back part, a fan-fold, and display items,
the front part and back part joined at one end by a hinge and the front part and back part joined at the other end by the fan-fold,
the front part with an outside surface, the outside surface of the front part with a transparent inside pocket, the transparent inside pocket attached fixedly to the outside surface of the front side on three sides of the outside surface and open at the fourth side,
the transparent inside pocket with a plurality of transparent pockets on its surface, the transparent pockets each having an open top and closed on the other three sides,
the back part with an outside surface, the back part outside surface with a storage pocket, the storage pocket closed on three sides and open on the fourth side, the open fourth side closeable with a closure lid, the closure lid held closed by a hook and loop closure means
the display items comprised of a plurality of background pictures and a plurality of display cards, the background pictures sized so that they will fit into the transparent inside pocket and fill it completely, the cards sized such that they will fit into the transparent pockets.

2. A standup pocket chart as in claim 1, where the front part is transparent.

3. A standup pocket chart as in claim 2, where the back part is configured identically to the front part.

4. A method of using the standup pocket chart comprised of the steps of
identifying what display items are to be held in the transparent inside pocket and transparent pockets of the standup pocket chart,
transporting the standup pocket chart and the display items to the place where it is to be used,
inserting a background picture, if any, in the transparent inside pocket,
standing up the standup pocket chart on its fan-fold end,
inserting one or more display cards in the transparent pockets on the standup pocket chart as desired,
rearranging the display cards and background pictures in the standup pocket chart as needed.
